(19) United States
(12) Patent Application Publication
(10) Pub. No.: US 2006/0152571 A1
(43) Pub. Date: Jul. 13, 2006

(54) Identification code drawing method, substrate, and display module

(75) Inventors: Yuji Iwata, Suwa (JP); Hironori Hasei, Okaya (JP); Hirotsuna Miura, Fujimi (JP)

Correspondence Address: HARNESS, DICKEY & PIERCE, P.L.C., P.O. BOX 828, BLOOMFIELD HILLS, MI, 48303, US

(73) Assignee: Seiko Epson Corporation

(21) Appl. No.: 11/328,777

(22) Filed: Jan. 10, 2006

(30) Foreign Application Priority Data
Jan. 11, 2005 (JP) 2005-003426

(51) Int. Cl. B41J 2/01

(52) U.S. Cl. 347/107

(57) ABSTRACT

An identification code drawing method of drawing an identification code on a substrate includes: discharging liquid droplets of functional liquid, into which particles of metal or metal oxide are dispersed, from nozzles of a liquid droplet discharging head on the basis of liquid droplet discharge data for drawing an identification code so as to attach the liquid droplets on the substrate; and heating or drying the liquid droplets attached on the substrate to fix the particles contained in the liquid droplets on the substrate so that the identification code is drawn on the substrate.

### BACKGROUND

1. Technical Field

The present invention relates to an identification code drawing method, to a substrate, and to a display module.

2. Related Art

In the related art, in an electro-optical device such as a liquid crystal display device, an organic electroluminescent display device (organic EL display device), or the like, a plurality of electro-optical elements are formed on a substrate. In general, on this type of substrate, a unique identification code such as a barcode in which a serial number or the like is encoded for the purpose of quality and product management is drawn. The identification code is read by a dedicated code reader so as to be decoded.

In the meantime, the substrate on which the identification code is formed not only goes through the manufacturing processes of electro-optical elements, but also the cleaning/heating processes between the manufacturing processes. Therefore, the substrate is required to be abrasion-resistant, chemically-resistant, and heat-resistant.

Due to such a problem, a method where heat-resistant adhesive seal in which an identification code is drawn is affixed on a substrate, or a method where an identification code is directly drawn on a substrate by irradiation of laser beam is proposed. In addition, in JP-A-2003-127537, a method is proposed where water containing an abrasive material is jetted on a substrate to mark a number or the like on the substrate. Further, in JP-A-11-77340, a method is proposed where a laser beam is irradiated to transfer chrome coating on a substrate so that a mark is formed on the substrate.

In the above-described methods, there is an advantage in that an identification code which is difficult to be removed from a substrate can be formed. However, a special and expensive equipment such as a water jet device or laser sputtering device is needed, such that cost increases and reducing the size of the equipment is difficult. In addition, when an identification code is drawn by irradiation of a laser beam, power consumption increases. Alternately, when water, dust, or the like is attached on a substrate at the time of using a water jet device, a drying process or cleaning process is needed, thereby increasing the number of processes.

### SUMMARY

An advantage of some aspects of the invention is that it provides an identification code drawing method in which an identification code having high durability can be drawn on a substrate by a simple equipment, a substrate, and a display module.

According to an aspect of the invention, an identification code drawing method of drawing an identification code on a substrate includes: discharging liquid droplets of functional liquid, into which particles of metal or metal oxide are dispersed, from nozzles of a liquid droplet discharging head on the basis of liquid droplet discharge data for drawing an identification code so as to attach the liquid droplets on the substrate; and heating or drying the liquid droplets attached on the substrate to fix the particles contained in the liquid droplets on the substrate so that the identification code is drawn on the substrate.

According to the identification code drawing method of the aspect of the invention, liquid droplets of functional liquid, into which particles of metal or metal oxide are dispersed, are discharged from liquid droplet discharging nozzles to be attached on a substrate on the basis of liquid droplet discharge data for creating an identification code. Further, the liquid droplets attached on the substrate are dried and heated, and the particles are fixed onto the substrate, thereby forming an identification code. In other words, since an identification code is drawn on a substrate by particles of metal or metal oxide, an identification code having high durability can be formed on a substrate, which is excellent in heat-resistance, chemical-resistance, and abrasion-resistance. Furthermore, a liquid droplet discharging method is used, in which liquid droplets of functional liquid are discharged from a liquid droplet discharging head. Therefore, without requiring a complicated or expensive equipment, an identification code can be drawn on a substrate by a relatively simple device.

In the identification code drawing method, preferably, the particles dispersed into the functional liquid contain at least manganese or manganese oxide.

According to the identification code drawing method, since the particles dispersed into the functional liquid contain at least manganese or manganese oxide, particles having low conductivity can be formed. As a result, device breakdown or the like can be prevented from occurring even though the functional liquid is attached on an electronic apparatus or the like. In particular, when a substrate is used in a display module including various elements, the insulation of an insulating layer can be held even if a microscopic amount of particles is mixed in the insulating layer during the manufacturing process thereof.

Further, in the identification code drawing method, preferably, the particles dispersed into the functional liquid contain at least nickel or nickel oxide.

According to the identification code drawing method, since the particles dispersed into the functional liquid contain at least nickel or nickel oxide, the liquid droplets of functional liquid can be discharged from the liquid droplet discharging head in a condition which is suitable for creating an identification code.

Furthermore, in the identification code drawing method, preferably, the particles dispersed into the functional liquid contain at least silver or silver oxide.

According to the identification code drawing method, since the particles dispersed into the functional liquid contain at least silver or silver oxide, the liquid droplets of functional liquid can be discharged from the liquid droplet discharging head in a condition which is suitable for creating an identification code.

Furthermore, in the identification code drawing method, preferably, the particles dispersed into the functional liquid contain at least gold or gold oxide.

According to the identification code drawing method, since the particles dispersed into the functional liquid contain at least gold or gold oxide, the liquid droplets of functional liquid can be discharged from the liquid droplet discharging head in a condition which is suitable for creating an identification code.

Furthermore, in the identification code drawing method, preferably, the particles dispersed into the functional liquid contain at least copper or copper oxide.

According to the identification code drawing method, since the particles dispersed into the functional liquid contain at least copper or copper oxide, the liquid droplets of functional liquid can be discharged from the liquid droplet discharging head in a condition which is suitable for creating an identification code.

Furthermore, in the identification code drawing method, preferably, the identification code is a two-dimensional code.

According to the identification code drawing method, since the identification code is a two-dimensional code, a large amount of data can be written into a small drawing area.

According to another aspect of the invention, a substrate includes a code drawing region where an identification code is drawn. In the substrate, on the basis of liquid droplet discharge data for drawing an identification code, liquid droplets of functional liquid into which particles of metal or metal oxide are dispersed are discharged onto the code drawing region from nozzles of a liquid droplet discharging head so that the liquid droplets of functional liquid are attached on the code drawing region. The liquid droplets attached on the substrate are at least heated or dried, and the particles contained in the liquid droplets are fixed on the code drawing region, so that the identification code is drawn.

According to the aspect, a substrate includes a code drawing region where an identification code is drawn. The substrate is subjected to a process where, on the basis of liquid droplet discharge data for drawing an identification code, liquid droplets of functional liquid into which particles of metal or metal oxide are dispersed are discharged from nozzles of a liquid droplet discharging head so as to be attached on the code drawing region. In addition, the liquid droplets attached on the substrate are heated or dried, so that the particles are closely attached on the substrate. In other words, since an identification code is drawn on a substrate by particles of metal or metal oxide, an identification code having high durability can be formed on a substrate, which is excellent in heat-resistance, chemical-resistance, and abrasion-resistance. Furthermore, the liquid droplet discharging method is used, in which liquid droplets of functional liquid are discharged from a liquid droplet discharging head. Therefore, without requiring a complicated or expensive equipment, an identification code can be drawn on a substrate by a relatively simple device.

According to still another aspect of the invention, a display module includes the above-described substrate.

According to the aspect, a substrate provided in a display module includes a code drawing region where an identification code is drawn. The substrate is subjected to a process where, on the basis of liquid droplet discharge data for drawing an identification code, liquid droplets of functional liquid into which particles of metal or metal oxide are dispersed are discharged from nozzles of a liquid droplet discharging head so as to be attached on the code drawing region. In addition, the liquid droplets attached on the substrate are heated or dried, so that the particles are closely attached on the substrate. In other words, since an identification code is drawn on a substrate by particles of metal or metal oxide, an identification code having high durability can be formed on a substrate, which is excellent in heat-resistance, chemical-resistance, and abrasion-resistance. Furthermore, the liquid droplet discharging method is used, in which liquid droplets of functional liquid are discharged from a liquid droplet discharging head. Therefore, without requiring a complicated or expensive equipment, an identification code can be drawn on a substrate by a relatively simple device.

### BRIEF DESCRIPTION OF THE DRAWINGS

The invention will be described with reference to the accompanying drawings, wherein like numbers reference like elements.

FIG. 1 is a front view illustrating essential parts of a liquid droplet discharging apparatus of the present embodiment.

FIG. 2 is a plan view illustrating essential parts of the same liquid droplet discharging apparatus.

FIG. 3 is an expanded view illustrating a liquid droplet discharging head.

FIG. 4 is a block diagram explaining the construction of the same liquid droplet discharging apparatus.

FIG. 5 is a schematic view illustrating a code drawing region provided on a substrate after a liquid droplet discharging process.

FIG. 6 is a schematic view illustrating a code drawing region after a heating process.

FIG. 7 is a schematic view illustrating a display module.

FIG. 8 is a perspective view illustrating a cellular phone including the same display module.

### DESCRIPTION OF EXEMPLARY EMBODIMENTS

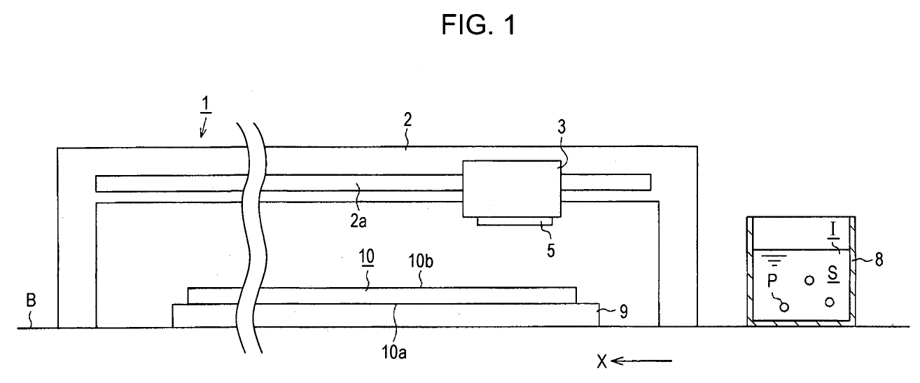

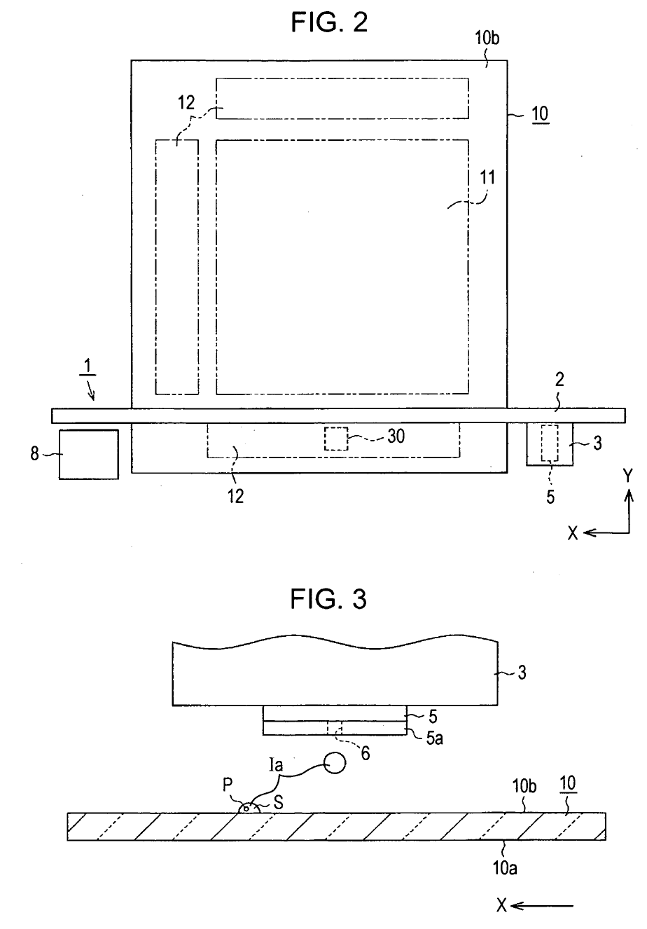

Hereinafter, an embodiment to which the invention is embodied will be described with reference to FIGS. 1 to 8. FIGS. 1 and 2 are front and plan views illustrating essential parts of a liquid droplet discharging apparatus 1, respectively.

As shown in FIGS. 1 and 2, the liquid droplet discharging apparatus 1 includes a supporting unit 2 erected on a supporting table B. The supporting unit 2 is erected along a main scanning direction (an X direction and a direction opposite thereto in FIGS. 1 and 2) on a predetermined region of the supporting table B. In the supporting unit 2, a main scanning guide rail 2a is arranged to extend in the main scanning direction.

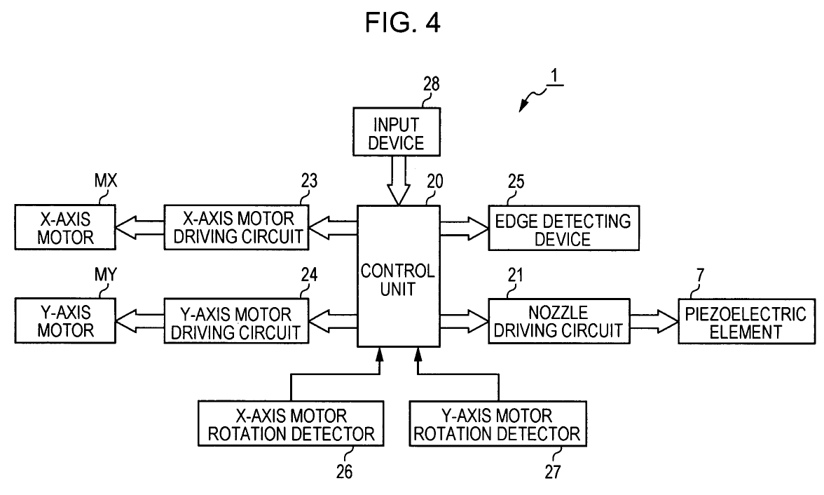

In the main scanning guide rail 2a, a carriage 3 is slidably provided. The carriage 3 can be reciprocated in the main scanning direction along the main scanning guide rail 2a by an X-axis motor MX (refer to FIG. 4) and an X-axis driving mechanism (not shown).

In addition, in the carriage 3, a liquid droplet discharging head 5 is integrally provided. As shown in FIG. 3, the liquid droplet discharging head 5 includes a nozzle plate 5a on the lower surface thereof. In the present embodiment, sixteen liquid droplet discharging nozzles 6 (hereinafter, simply referred to as the nozzles 6) are formed to penetrate through the nozzle plate 5a, respectively. The respective nozzles 6 are formed at predetermined intervals so as to be arranged in a line in the sub scanning direction (a Y direction and a direction opposite thereto in FIG. 2).

Further, the liquid droplet discharging head 5 includes piezoelectric elements 7 (refer to FIG. 4) corresponding to the respective nozzles 6. By the control of voltages applied to the respective piezoelectric elements 7, the piezoelectric elements 7 are deformed. Then, metallic ink I (refer to FIG. 1) serving as functional liquid which is temporarily stored in the liquid droplet discharging head 5 is transformed into liquid droplets to be discharged from the nozzles 6.

In addition, the carriage 3 is connected to an ink tank 8 through a supply mechanism (not shown). The ink tank 8 stores the metallic ink I therein, which is supplied to the liquid droplet discharging head 5 through the supply mechanism. As schematically shown in FIG. 1, the metallic ink I contains dispersion medium S and metallic particles P of metal or metal oxide dispersed in the dispersion medium S.

The dispersion medium S such as water, alcohol, hydrocarbons, or the like can be discharged from the liquid droplet discharging head 5 so as to form liquid droplets having a predetermined diameter. Further, the dispersion medium S may be a liquid which can disperse the metallic particles P. In addition, the metallic particles P dispersed in the dispersion medium S are metal elements (or metal oxide) having poor conductivity. In the present embodiment, the metallic particles are manganese particles. It is preferable that the metallic particles P have particle diameters in the range of 1 nm to 0.1 nm, but the particle can have diameters large enough for the particles to be discharged from the liquid discharging head 5. Further, it is preferable that a coating layer made of an organic material or the like be formed on the metallic particle P.

As shown in FIG. 1, a conveying unit 9 is arranged below the liquid droplet discharging head 5. The conveying unit 9 can be relatively moved in the sub scanning direction with respect to the moving direction of the liquid droplet discharging head 5 by a Y-axis motor MY (refer to FIG. 4) and a Y-axis driving mechanism (not shown). In the present embodiment, the Y-axis driving mechanism is composed of a driving mechanism such as a conveying roller, which delivers the conveying unit 9 in the sub scanning direction. In addition, the conveying unit 9 is composed of a conveying belt or the like, but may be composed of a conveying roller.

As shown in FIGS. 1 and 2, a glass substrate 10 (hereinafter, simply referred to as the substrate 10) which is used in a display module is placed on the conveying unit 9, with a back surface 10b thereof facing upward. On a front surface 10a (the back side of FIG. 2, refer to FIG. 1) of the substrate 10, an electro-optical element is formed in a first region 11, and circuit elements of a scanning line driving circuit and data line driving circuit are respectively formed in second regions 12, as shown by a two-dot chain line in FIG. 2.

In the present embodiment, the substrate 10 is previously subjected to a cleaning process before the respective circuit elements and the electro-optical element are formed. Then, the substrate 10 is disposed to be fixed on the conveying unit 9, with the back surface 10b thereof facing upward as shown in FIG. 2. The substrate 10 placed on the conveying unit 9 can be relatively moved in the sub scanning direction with respect to the liquid droplet discharging head 5 by the Y-axis motor MY and the Y-axis driving mechanism. In addition, the liquid droplet discharging head 5 can be relatively moved in the main scanning direction with respect to the substrate 10 which is disposed to be fixed on the conveying unit 9 by the driving of the X-axis motor MX and the X-axis driving mechanism.

Next, an electrical construction of the liquid droplet discharging apparatus 1 will be described with reference to FIG. 4. As shown in FIG. 4, a control unit 20 includes a CPU, a RAM, a ROM, and so on, and conveys the substrate 10 driven by the conveying unit 9 and performs a liquid droplet discharging operation according to the control program stored in a ROM or the like and an identification code (two-dimensional code) creating program. In addition, in the ROM, bitmapped data for creating a two-dimensional code on the substrate 10 are stored beforehand. The bitmapped data is where identification data composed of characters and numbers such as a serial number, a lot number, and the like are two-dimensionally encoded and further bitmapped by a known method.

In addition, the control unit 20, which is connected to a nozzle driving circuit 21, outputs a nozzle driving signal to the nozzle driving circuit 21. Based on the nozzle driving signal from the control unit 20, the nozzle driving circuit 21 drives the piezoelectric elements 7 to which electric power is applied in response to the nozzle driving signal among the respective piezoelectric elements 7 provided on the liquid droplet discharging head 5. Further, the droplet-like metallic ink I from the nozzles 6 corresponding to the piezoelectric elements 7 is discharged toward the substrate 10.

In addition, the control unit 20, which is connected to the X-axis motor driving circuit 23, outputs an X-axis motor driving control signal to the X-axis motor driving circuit 23. The X-axis motor driving circuit 23 responds to the X-axis motor driving control signal from the control unit 20 to normally or reversely rotate the X-axis motor MX. For example, if the X-axis motor MX is normally rotated, the carriage 3 moves in the arrow X direction. On the contrary, if the X-axis motor MX is reversely rotated, the carriage 3 moves in the direction opposite to the arrow X direction.

In addition, the control unit 20, which is connected to the Y-axis motor driving circuit 24, outputs an Y-axis motor driving control signal to the Y-axis motor driving circuit 24. The Y-axis motor driving circuit 24 responds to the Y-axis motor driving control signal from the control unit 20 to normally or reversely rotate the Y-axis motor MY. For example, if the Y-axis motor MY is normally rotated, the conveying unit 9 is moved in the arrow Y direction. On the contrary, if the Y-axis motor MY is reversely rotated, the conveying unit 9 is relatively moved in the direction opposite to the arrow Y direction.

Further, the control unit 20 is connected to an edge detecting device 25. The edge detecting device 25 is composed of, for example, a sensor for detecting the edge of the substrate 10, a camera for image-capturing the substrate 10, and the like. When the edge detecting device 25 is composed of an optical sensor, the edge detecting device 25 detects the edge of the substrate 10 from the reflectivity difference between the substrate 10 and the conveying unit 9 so as to output a detection signal to the control unit 20. When the edge detecting device 25 is composed of an image capturing device including a camera, image data captured by the camera is analyzed by an image processing unit provided in the imaging device, and the edge detecting device 25 detects that the substrate 10 is conveyed to a predetermined position. Further, the edge detecting device 25 outputs a detection signal to the control unit 20.

In addition, the control unit 20, which is connected to an X-axis motor rotation detector 2, receives a detection signal from the X-axis motor rotation detector 26. Based on the detection signal, the control unit 20 detects the rotation direction and rotation amount of the X-axis motor MX so as to calculate the movement and direction of the liquid droplet discharging head 5 (the carriage 3) in the main scanning direction. In addition, based on the detection signal from the Y-axis motor rotation detector, the control unit 20 detects the rotation direction and rotation amount of the Y-axis motor MY so as to calculate the movement and direction of the liquid droplet discharging head 5 in the sub scanning direction with respect to the substrate 10.

When the control unit 20 receives a detection signal from the edge detecting device 25, the position of the substrate 10 at that time, for example, is set to a reference position. In addition, the Y-axis motor driving circuit 24 is driven to move the conveying unit 9 in the sub scanning direction. Further, based on a detection signal from a Y-axis motor rotation detector 27, the control unit moves the substrate 10 on the conveying unit 9 to a predetermined Y-axis position, while calculating the direction and movement thereof.

In addition, the control unit 20 is connected to an input device 28. The input device 28 has operation switches such as a start-up switch and a stop switch, and outputs operation signals generated by the operation of the respective switches to the control unit 20.

Next, a two-dimensional code drawing process will be described. First, as shown in FIGS. 1 and 2, the substrate 10 is disposed to be fixed so that the back surface 10b thereof faces upward. At this time, the carriage 3 is disposed in a home position, for example, as shown in FIG. 2. The home position is provided at the right end side (or the left end side) of a region where the carriage 3 is movable.

In addition, the control unit 20 drives the Y-axis motor MY through the Y-axis motor driving circuit 24, while waiting for a signal from-the edge detecting device 25 indicating that the edge of the substrate 10 is detected. If the control unit 20 receives a detection signal from the edge detecting device 25, the control unit 20 moves the substrate 10 to a predetermined Y-axis position, while calculating the movement and direction of the substrate 10 in the sub scanning direction based on the detection signal from the Y-axis motor rotation detector 27. In the present embodiment, the predetermined Y-axis position is set to the position where the liquid droplet discharging head 5 corresponds to the back surface 10b of the second region 12 on the substrate 10 in the sub scanning direction, as shown in FIG. 2.

At the same time, the control unit 20 reads the bitmapped data stored in the ROM according to a code creating program. Further, the control unit converts the bitmapped data into liquid droplet discharge data for driving the liquid droplet discharging head 5.

When the substrate 10 is moved to the predetermined Y-axis position, the control unit 20 drives the X-axis motor MX by the X-axis motor driving circuit 23, while calculating the movement in the arrow X direction on the basis of the detection signal from the X-axis motor rotation detector 26. Further, the control unit 20 moves the liquid droplet discharging head 5 to a predetermined X-axis position. In the present embodiment, the predetermined X-axis position is set to the upper position of a code drawing region 30 provided on the back surface 10b of the second region 12 in the lower side of FIG. 2.

The code drawing region 30 is set in a rectangular shape to have 1 mm×1 mm to 2 mm×2 mm size. In addition, the code drawing region 30 is hypothetically divided into 16×16 cells 31, as shown in FIG. 5. According as ink droplets of the metallic ink I are discharged or not, each of the cells 31 becomes a white cell (non-discharged portion) to which the metallic ink I is not impacted or a black cell (discharged portion) to which the metallic ink is attached. Moreover, in FIG. 2, the code drawing region 30 is enlarged for the sake of convenience.

If the liquid droplet discharging head 5 is moved to the upper position (the predetermined X-axis position) of the code drawing region 30, the control unit 20 outputs a nozzle driving signal to the nozzle driving circuit 21 on the basis of the created liquid droplet discharge data, while driving the X-axis motor MX to move the carriage 3 in the sub scanning direction. In other words, at the same time when the carriage 3 on which the liquid droplet discharging head 5 is mounted moves in the main scanning direction, the piezoelectric elements 7 are driven to be deformed by the nozzle driving circuit 21. As a result, based on the liquid droplet discharge data, the metallic ink I is discharged from the respective nozzles 6 toward the cells each of which is set to a black cell. Thereby, an ink droplet Ia landed on a cell is attached in a hemispheric shape onto a cell to which the ink droplet is to be discharged, as shown in FIG. 3.

Further, when the liquid droplet discharging head 5 completes one-scanning operation of discharging liquid droplets, a cell 31a in which the ink droplet Ia is impacted and a cell 31b in which the ink droplet Ia is not impacted are formed in the code drawing region 30, as shown in FIG. 5. On the cell 31a in which the metallic ink I is impacted, the ink droplet Ia having a hemispheric shape is attached. Moreover, although a two-dimensional code in a data matrix is shown in FIG. 5, a two-dimensional code may be formed in other forms.

When the discharging of metallic ink I is completed on the basis of the liquid droplet discharge data, the control unit 20 outputs a Y-axis motor driving control signal to the Y-axis axis driving circuit 24 to reverse the substrate 10 from the lower position of the liquid droplet discharging head 5.

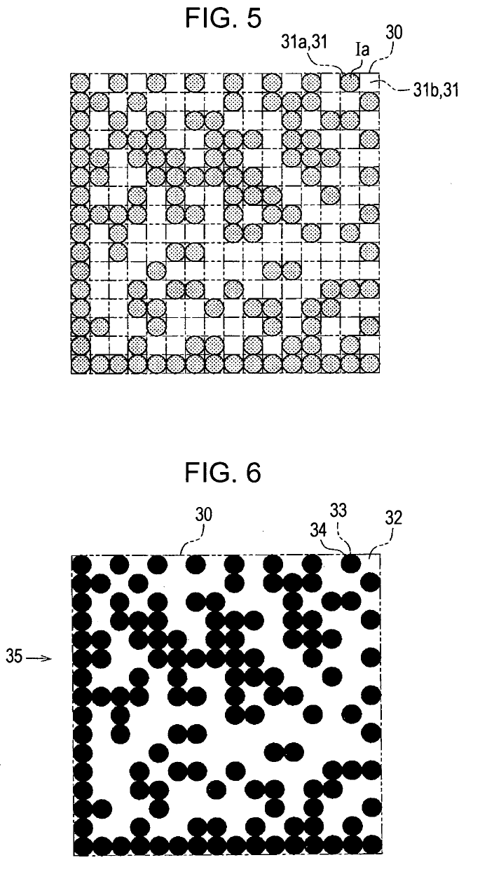

After the liquid droplet discharging process for creating a two-dimensional code is finished, the substrate 10 is switched over to a heating process. Here, the substrate 10 is heated by using a hot plate, a hot air furnace, or the like. In the present embodiment, the substrate 10 is heated at a temperature where the metallic particles P can be sintered. Accordingly, the dispersion medium S of the metallic ink I impacted in the code drawing region 30 is evaporated, so that the respective metallic particles P are fixed on the substrate 10. The metallic particles P fixed on the substrate 10 are sintered and then bonded to each other so as to be cured. Therefore, as shown in FIG. 6, a two-dimensional code pattern 35 serving as an identification code having high durability is formed in the code drawing region 30, where the white cells 32 in which the metallic ink I is impacted and the black cells 33 in which dots 34 formed by the fixation of metallic particles P are drawn are formed.

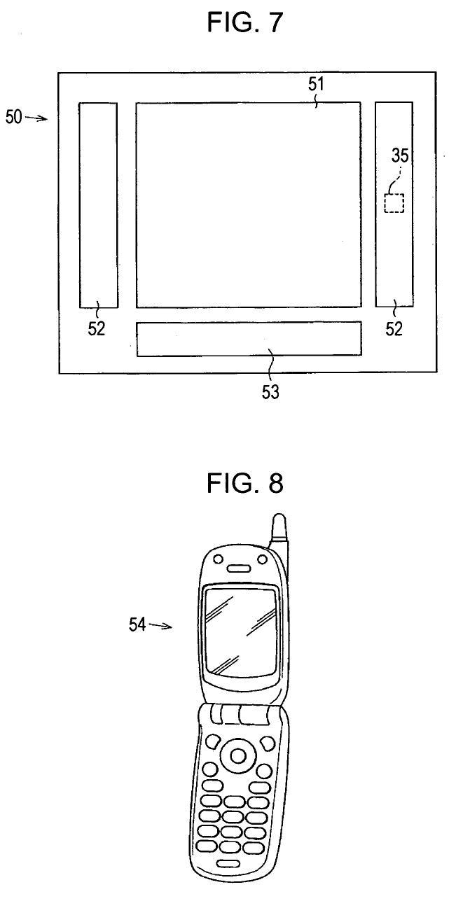

The substrate 10 where the two-dimensional code pattern 35 is formed is subjected to various processes for forming an electro-optical element and cleaning and heating processes between the various processes so as to become a display module 50 shown in FIG. 7. The display module 50 is provided with a display unit 51, in which liquid crystal is sealed, in the first region 11 of the substrate 10. Further, the display module 50 is provided with scanning line driving circuits 52 and a data line driving circuit 53 in the respective second regions 12. In FIG. 7, the two-dimensional code pattern 35 is formed on the back surface 10b of the substrate 10 on which the right-side scanning line driving circuit 52 is disposed. The two-dimensional code pattern 35 can be read by a two-dimensional code reader (not shown) from the back surface 10b. In addition, the display module 50 is used in an electronic apparatus such as a cellular phone 54 shown in FIG. 8, a mobile-type personal computer, a digital camera, or the like.

According to the above-described embodiment, the following effects can be obtained.

(1) In the above-described embodiment, the two-dimensional code pattern 35 is drawn on the substrate 10 which is used in the display module 50. Further, when the two-dimensional code pattern 35 is drawn, the ink droplets Ia of the metallic ink I into which the metallic particles P such as metal or metal oxide are dispersed are first discharged from the liquid droplet discharging head 5 based on the bitmapped data stored in the control unit 20 so as to be attached on the back surface 10b of the substrate 10. Then, the liquid droplets Ia attached on the substrate 10 are heated or dried, so that the metallic particles P within the ink droplets Ia are fixed on the substrate 10. In other words, since the metallic ink I into which the metallic particles P made of metal or metal oxide are dispersed are used, the two-dimensional code pattern 35 having high durability can be formed on the substrate 10. Furthermore, since a liquid droplet discharging method in which the ink droplets Ia are discharged from the liquid droplet discharging head 5 is used, the two-dimensional code pattern 35 can be drawn on the substrate 10 by a relatively simple device, without requiring a special or large-sized equipment.

(2) In the above-described embodiment, the metallic particles P which are dispersed into the metallic ink I are composed of manganese particles. For this reason, even though mist of the metallic ink I attaches to other devices or the like, device breakdown or the like can be prevented from being caused by the mist. In addition, even though a microscopic amount of metallic particle P is mixed in an insulating film formed on the substrate 10 in a manufacturing process, the insulation of the insulating film can be held.

(3) In the above-described embodiment, the liquid droplet discharging method is used to create the two-dimensional code pattern 35. For this reason, the two-dimensional code having high durability can be created without deforming the substrate 10 such as a mark caused by laser irradiation, water jet, or the like. Therefore, without preventing the degree of freedom in design of the display module 50, the two-dimensional code pattern 35 can be drawn on the substrate 10.

Moreover, the above-described embodiment may be modified as follows.

The Y-axis driving mechanism of the liquid droplet discharging apparatus 1 may be composed of a driving mechanism which moves the supporting unit 2 in the sub scanning direction.

In the above-described embodiment, the substrate 10 in which the metallic ink I is impacted is heated. However, the substrate 10 may be simply dried when it is left at low temperature (including room temperature) so that the dispersion medium S is evaporated and the metallic particles P of the metallic ink I are fixed (or sintered) on the substrate 10.

The metallic particles P which are contained in the metallic ink I may be composed of one or several among manganese, nickel, silver, gold, and copper. In addition, the metallic particles P may be composed of one or several among a manganese oxide, nickel oxide, silver oxide, gold oxide, and copper oxide. Further, the metallic particles may be composed of one or several among the above metals and one or several among the above metallic oxides.

The substrate 10 may be formed of a silicon wafer, a resin film, a metallic plate, or the like.

In the present embodiment, 16 nozzles 6 are provided in the liquid droplet discharging head 5, but the number of nozzles is not limited to 16.

In the above-described embodiment, the display module 50 is embodied as a liquid crystal display module without being limited thereto, for example, the display module 50 may be embodied to an organic EL display module. In addition, the display module 50 may be used as a display module, which includes an electron emission element having a planar shape and a field-effect display (FED, SED, or the like) using the emission of fluorescent material by electrons emitted from the same element. In addition, the substrate 10 on which the two-dimensional code pattern 35 is drawn may be used in other electronic apparatuses as well as in the above displays.

What is claimed is:

1. An identification code drawing method of drawing an identification code on a substrate, comprising:
discharging liquid droplets of functional liquid, into which particles of metal or metal oxide are dispersed, from nozzles of a liquid droplet discharging head on the basis of liquid droplet discharge data for drawing an identification code so as to attach the liquid droplets on the substrate; and
heating or drying the liquid droplets attached on the substrate to fix the particles contained in the liquid droplets on the substrate so that the identification code is drawn on the substrate.

2. The method according to claim 1,
wherein the particles dispersed into the functional liquid contain at least manganese or manganese oxide.

3. The method according to claim 1,
wherein the particles dispersed into the functional liquid contain at least nickel or nickel oxide.

4. The method according to claim 1,
wherein the particles dispersed into the functional liquid contain at least silver or silver oxide.

5. The method according to claim 1,
wherein the particles dispersed into the functional liquid contain at least gold or gold oxide.

6. The method according to claim 1,
wherein the particles dispersed into the functional liquid contain at least copper or copper oxide.

7. The method according to claim 1,
wherein the identification code is a two-dimensional code.

8. A substrate comprising:
a code drawing region where an identification code is drawn,
wherein, on the basis of liquid droplet discharge data for drawing an identification code, liquid droplets of functional liquid into which particles of metal or metal oxide are dispersed are discharged onto the code drawing region from nozzles of a liquid droplet discharging head so that the liquid droplets of functional liquid are attached on the code drawing region, and
the liquid droplets attached on the substrate are at least heated or dried and the particles contained in the liquid droplets are fixed on the code drawing region, so that the identification code is drawn.

9. A display module comprising the substrate according to claim 8.
